(19) United States
(12) Patent Application Publication
(10) Pub. No.: US 2016/0085272 A1
(43) Pub. Date: Mar. 24, 2016

(54) HOST COMPUTER

(71) Applicant: HCS AUDIO TECHNOLOGY LIMITED, SHATIN (HK)

(72) Inventors: MARK CHIEN, Hong Kong (HK); CHUL CHUNG, Hong Kong (HK); LAP SHUN HUI, Santa Clara, CA (US)

(21) Appl. No.: 14/859,485

(22) Filed: Sep. 21, 2015

Related U.S. Application Data
(60) Provisional application No. 62/052,978, filed on Sep. 19, 2014.

(51) Int. Cl. G06F 1/16; H01R 13/73; G06F 13/40; H01R 27/02

(52) U.S. Cl. CPC G06F 1/1684; H01R 27/02; H01R 13/73; G06F 13/4022; H01R 2107/00

(57) ABSTRACT

A host computer includes a computing box and a base. The computing box includes a box connector and outputs two different kinds of video signals via the box connector. The base includes a first interface, a second interface, and a base connector connected to the box connector. The first interface receives one of the two different kinds of video signals, and the second interface receives the other one of the two different kinds of video signals. The first interface outputs the one of the two different kinds of video signals to a display device, and the second interface outputs the other one of the two different kinds of video signals to another display device.

### CROSS-REFERENCE TO RELATED APPLICATIONS

This application claims priority to U.S. Provisional Application No. 62/052,978, filed on Sep. 19, 2014, the contents of which are incorporated by reference herein.

### FIELD

The subject matter herein generally relates to host computers, and more particularly to portable host computer.

### BACKGROUND

There exist two main types of computing platforms, personal computers and mobile devices. The personal computer typically includes a processing unit, a display monitor, a keyboard, a hard disk storage device, and one or more of I/O devices. The mobile device can include a processing unit and an I/O device such as a touch sensitive display. Mobile devices cannot execute the high performance software in the personal computers because of number of reasons (e.g. the different operating systems). Users often purchase both the personal computer for home or office use due to shortcomings inherent in the mobile devices.

### BRIEF DESCRIPTION OF THE DRAWINGS

Implementations of the present technology will now be described, by way of example only, with reference to the attached figures.

FIG. 1 is an exploded and isometric view of one embodiment of a host computer.

FIG. 2 is a block view of the host computer of FIG. 1.

FIG. 3 is a schematic view of the host computer of FIG. 1 connected to a display monitor via a cable.

FIG. 4 is a schematic view of the host computer of FIG. 1 connected to a television via a cable.

FIG. 5 is a schematic view of the host computer of FIG. 1 connected to a mobile phone via a cable.

FIG. 6 is a schematic view of the host computer of FIG. 1 connected to a mobile phone via wireless mode.

FIG. 7 is a flow chart of the host computer connected to other device via wireless mode.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

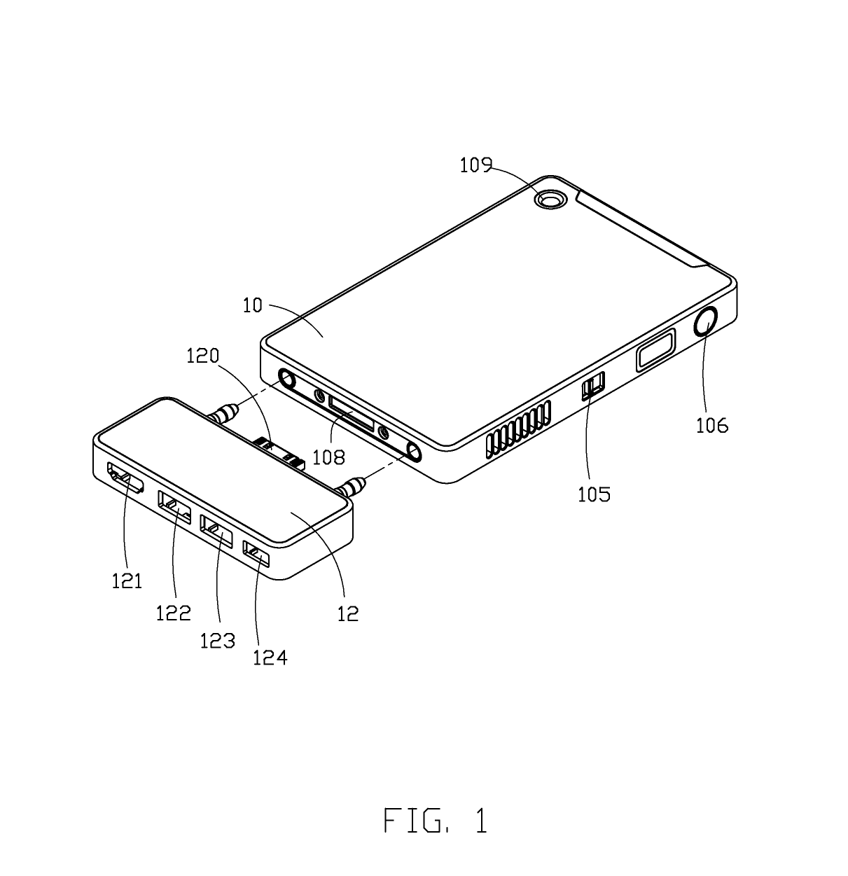

FIG. 1 illustrates a host computer in accordance with an embodiment including a computing box 10 and a base 12. The computing box 10 is configured to be mounted on the base 12 and electrically connected to the base 12.

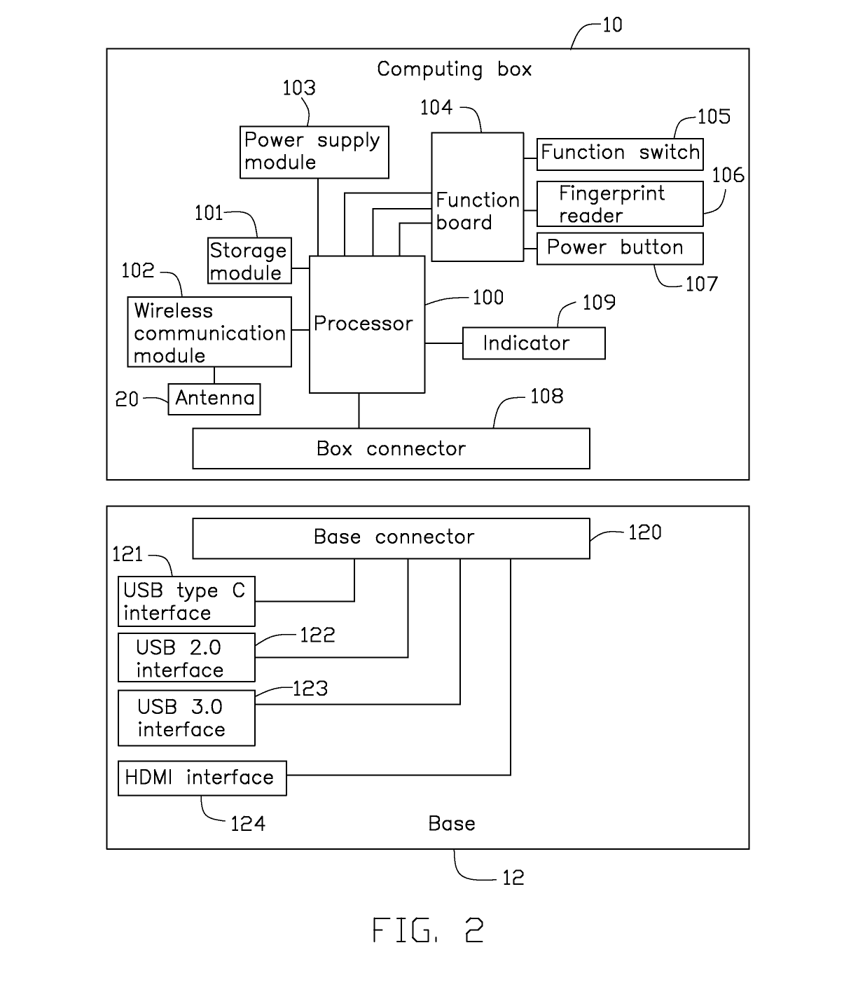

FIG. 2 illustrates a block view of the computing box 10 and the base 12. The computing box 10 includes a processor 100, a storage module 101, a wireless communication module 102, a power supply module 103, a function board 104, a function switch 105, a fingerprint reader 106, a power button 107, a box connector 108, and an indicator 109. The storage module 101, the wireless communication module 102, the power supply module 103, the function board 104 and the box connector 108 are connected to the processor 100. The function switch 105, the fingerprint reader 106, and the power button 107 are connected to the function board 104. The wireless communication module 102 is connected to an antenna 20.

The processor 100 is a main unit of the computing box 10. The processor 100 processes data for the computing box 10. The processor 10 can be any type processor, such as Intel company's “Cherry Trail” processor or Qualcomm company's “SNAPDRAGON” processor, and so on.

The storage module 101 includes a memory unit and a mass data storage unit. The memory unit works with the processor 100 to provisionally store data for the processor 100. The mass data storage unit works as a hard disk driver to store mass data therein.

The wireless communication module 102 is used to provide a wireless communication mode for the computing box 10. In at least one embodiment, the wireless communication module 102 is a WiFi module, or a bluetooth module, or a combination module combining the WiFi module and the bluetooth module.

The power supply module 103 provides power to the computing box 10. In at least one embodiment, the power supply module 103 includes a battery and an adapter. The adapter connects to commercial power to charge the battery and supply power to the computing box 10. The battery supplies power to the computing box 10 when the adapter is not connected to the commercial power.

The function board 104 configures the function switch 105 to some particular function. In at least one embodiment, the function switch 105 is configured to control the wireless communication module 102 to be on or off. The indicator 109 is used to indicate a state of the wireless communication module 102. For example, when the wireless communication module 102 is turned on, the indicator 109 lights on, and when the wireless communication module 102 is turned off, the indicator 109 lights off.

The power button 107 is used to power on or off the computing box 10.

The fingerprint reader 106 is used to detect a fingerprint to log in the computing box 10. Therefore, the computing box 10 is protected from unauthorization access.

The box connector 108 includes a plurality of pins. In at least one embodiment, the box connector 108 can transmit a plurality of signals, such as USB (Universal Serial Bus) 2.0 signal, USB 3.0 signal, USB 3.1 signal, HDMI (High Definition Multimedia Interface) signal, and other control signal. The plurality of signals can be transmitted simultaneously or individually. In at least one embodiment, the processor 100 transforms video signal into the USB signal (USB 2.0 signal, USB 3.0 signal, or USB 3.1 signal) and HDMI signal, and the computing box 10 outputs the USB signal and the HDMI signal simultaneously from the box connector 108. In another embodiment, the processor 100 transforms video signal into a type of signal according to a type of a device which the box connector is coupled to. For example, when the box connector 108 is coupled to a HDMI connector, the processor 100 transforms video signal into the HDMI signal; and when the box connector 108 is coupled to a USB connector, the processor 100 transforms video signal into the USB signal (USB 2.0 signal, USB 3.0 signal, or USB 3.1 signal).

The base 12 includes a base connector 120 and a plurality of interfaces connected to the base connector 120. The base connector 120 is configured to be connected the box connector 108 to receive the USB 2.0 signal, USB 3.0 signal, USB 3.1 signal, HDMI signal. In at least one embodiment, the plurality of interfaces includes a USB type C interface 121, a USB 2.0 interface 122, a USB 3.0 interface 123, and a HDMI interface 124. The USB type C interface 121 receives the USB 3.1 signal, the USB 2.0 interface 122 receives the USB 2.0 signal, and the USB 3.0 interface 123 receives the USB 3.0 signal, and the HDMI interface 124 receives the HDMI signal.

In at least one embodiment, the base 12 includes a projector. When the computing box 10 is mounted on the base 12, the computing box 10 transmits video signal to the base 12 and the projector projects corresponding image out.

In at least one embodiment, the base 12 includes a loudspeaker which can output sound when the computing box 10 transmits audio signal to the base 12.

In at least one embodiment, the base 12 is a protective case which can protect the computing box 10 from being damaged when the computer box 10 falls down.

In at least one embodiment, the base 12 includes a clock showing unit which can show time when the computer box transmits a time signal to the base 12.

In at least one embodiment, the base 12 is a display monitor, and the computing box 10 is mounted on the display monitor to transmit audio signal to the display monitor. Therefore, the computing box 10 and the display monitor together work as an all in one computer.

In at least one embodiment, the base 12 is equipped with a screen and a keyboard. When the computing box 10 is mounted on the base 12, the computing box 10 transmits audio signal to the screen, and receives input signal from the keyboard. Therefore, computing box 10 and the base 12 together works as a notebook computer. Further, a mouse (not shown) can be connected to the base 12 to input signal to the computing box 10.

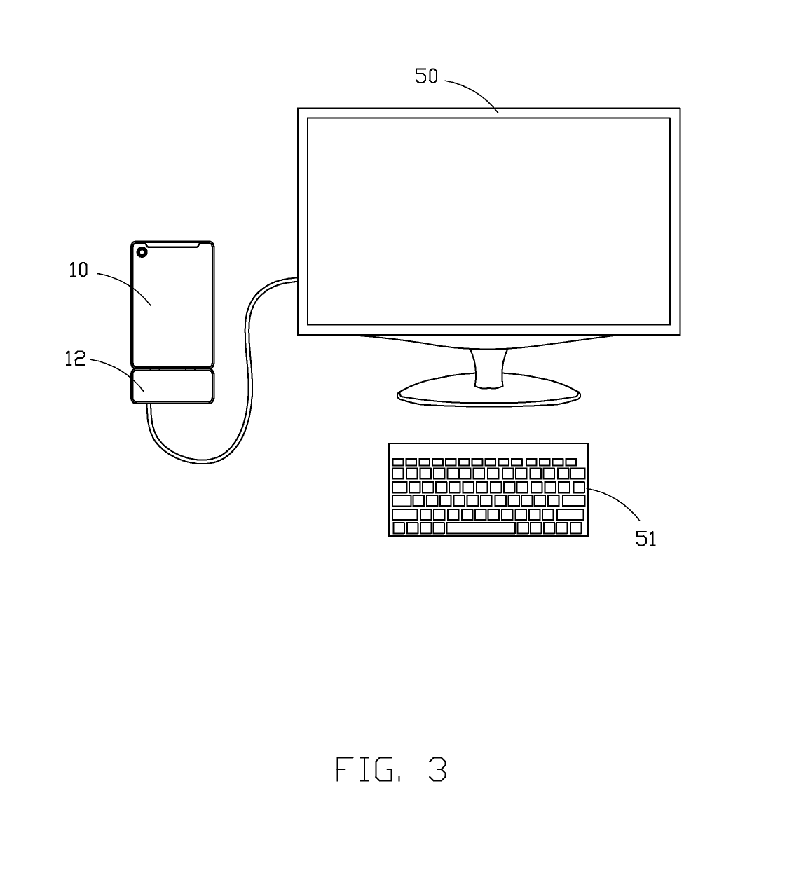

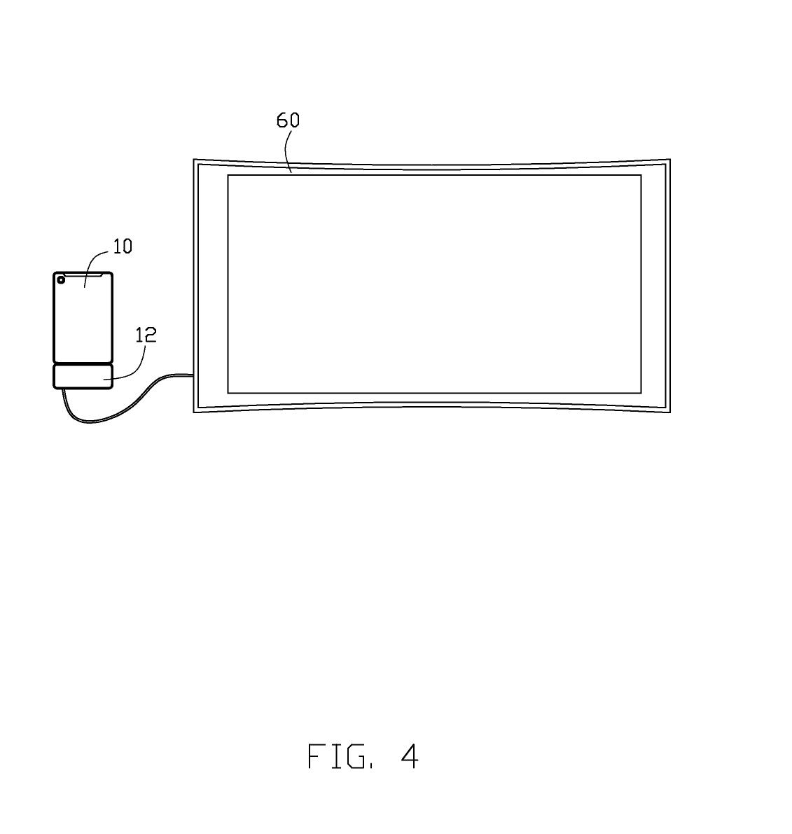

FIGS. 3 and 4 illustrate the computer box 10 and the base 12 assembly connecting to a display monitor 50 or a television 60. A HDMI cable connects the HDMI interface 124 of the base 12 to a corresponding HDMI port of the display monitor 50 or the television 60. The computer box 10 transmits HDMI video signal to the display monitor 50 or the television 60, and the display monitor 50 or the television 60 shows corresponding image thereon. The computing box 10 can wirelessly connect to a wireless keyboard 51 or wireless mouse (not shown) via the wireless communication module 102. Therefore, the computer box 10, the base 12, the display monitor 50 or the television 60, the wireless keyboard 51 and the mouse together work as a desktop computer.

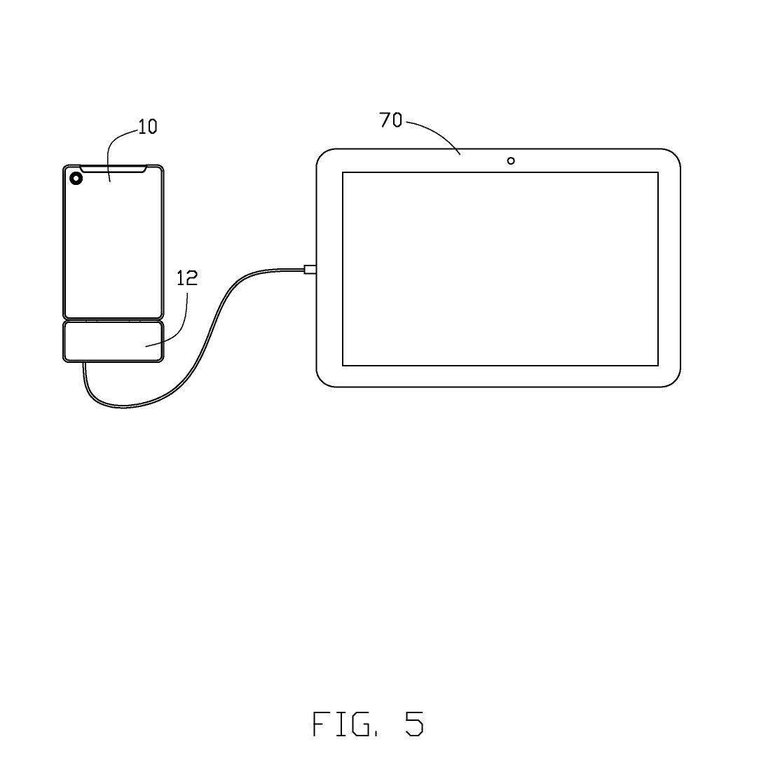

FIG. 5 illustrates the computer box 10 and the base 12 assembly connecting to a mobile phone 70. A USB cable connects the USB interfaces (USB type C interface, USB 2.0 interface, or USB 3.0 interface) to a corresponding USB port of the mobile phone 70. After the mobile phone 70 is connected to the base, a remote desktop connection function is activated in the mobile phone 70 to communicate the computing box 10 with the mobile phone 70. The computing box 10 is controlled via the remote desktop connection function by inputting name and password on the mobile phone 70. The computing box 10 can be controlled by inputting signals on the mobile phone 70, such as pressing a key of the mobile phone 70 or touching a touch screen of the mobile phone 70. Further, when power in a battery of the mobile phone 70 is less, the power supply module 103 of the computing box 10 can charge the battery of the mobile phone 70. In other embodiments, the mobile phone 70 can be a tablet computer.

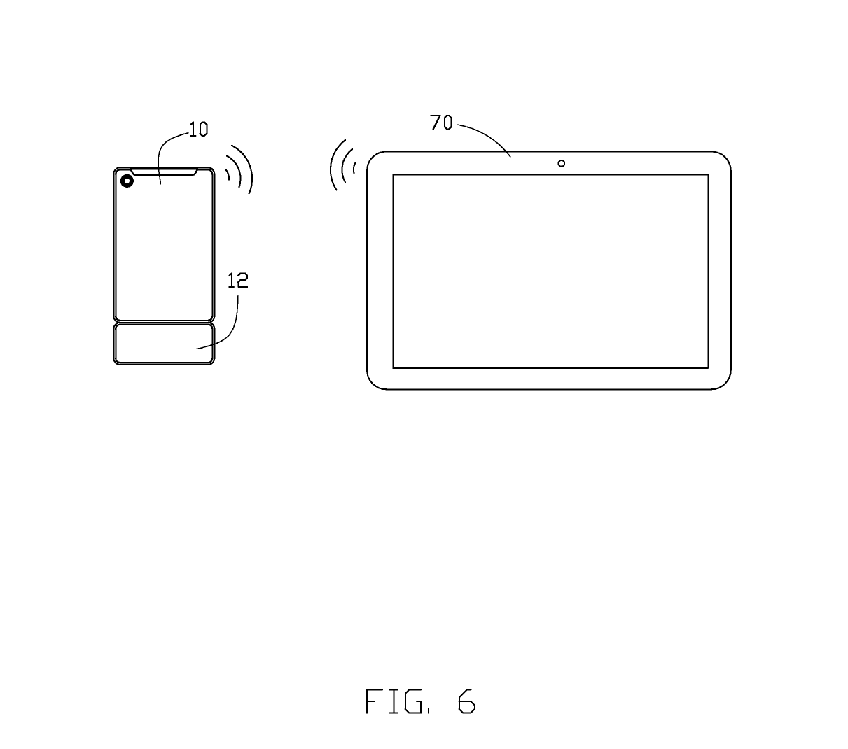

FIG. 6 illustrates the computer box 10 and the base 12 assembly connecting to the mobile phone 70 via wireless mode. After the wireless communication module 102 of the computing box 10 is turned on, the mobile phone 70 is wirelessly connected to the computing box 10 via the wireless communication module 102. It also can log in the computing box 10 on the mobile phone 70 via wireless mode.

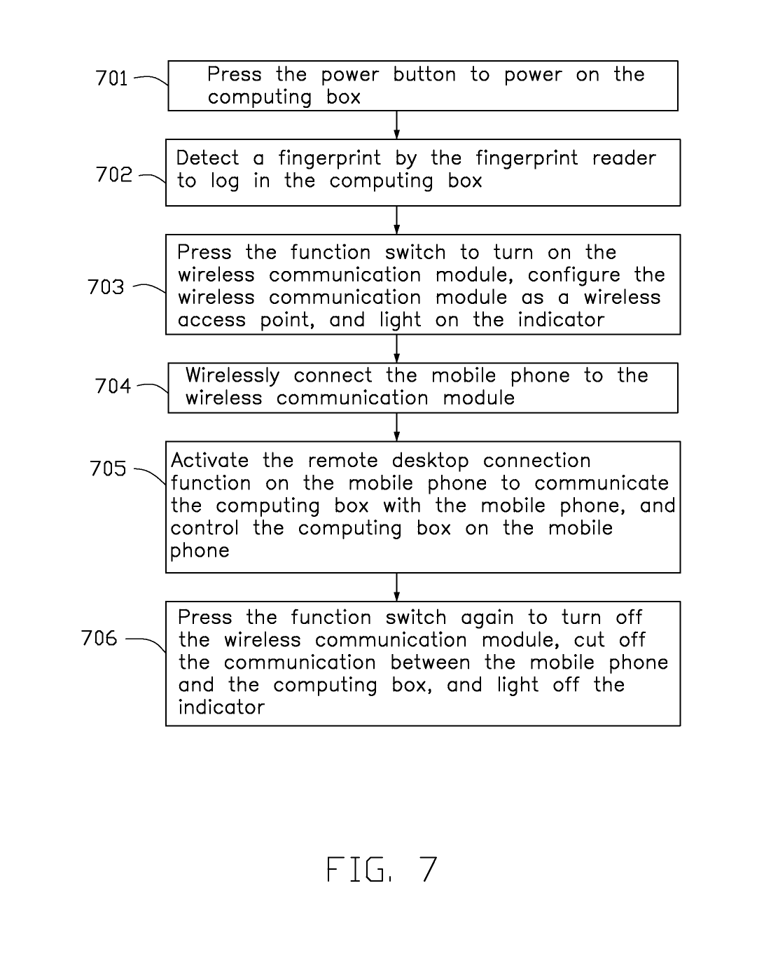

FIG. 7 illustrates a flow chart of a method for wirelessly connecting the mobile phone 70 to the computing box 10 includes the following steps.

At block 701, the method includes pressing the power button 107 to power on the computing box.

At block 702, the method includes detecting a fingerprint by the fingerprint reader 106 to log in the computing box. Further, it also can log in the computing box by usual method, such as inputting name and password.

At block 703, the method includes pressing the function switch 105 to turn on the wireless communication module 102, configuring the wireless communication module 102 as a wireless access point, and lighting on the indicator 109. For example, the wireless communication module 102 can be configured as a Ad-Hoc wireless communication equipment.

At block 704, the method includes wirelessly connecting the mobile phone 70 to the wireless communication module 102.

At block 705, the method includes activating the remote desktop connection function on the mobile phone 70 to communicate the computing box 10 with the mobile phone 70, and controlling the computing box 10 on the mobile phone 70.

At block 706, the method includes pressing the function switch 105 again to turn off the wireless communication module 102, cutting off the communication between the mobile phone and the computing box 10, and lighting off the indicator 109.

In the above steps, after the computing box 10 is idle for a during time, the computing box turns in a sleep mode, and the wireless communication module 102 is turned off simultaneously. When the computing box 10 turns from the sleep mode to a normal mode, the wireless communication module 102 is turned on simultaneously.

Further, the wireless communication module 102 can connect to a wireless router, and the mobile phone 70 can connect to Internet via the wireless communication module 102 and the wireless router.

Further, the computing box 10 and the base 12 can connect to other display device not limited to the display monitor, the television, the mobile phone, and the tablet computer. The base 12 also can equip other kinds of interface not limited to USB interface and HDMI interface to transmit video signal.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to, and including, the full extent established by the broad general meaning of the terms used in the claims. It will therefore be appreciated that the embodiments described above may be modified within the scope of the claims.

What is claimed is:

1. A computing box configured to be coupled to a base, the computing box comprising:
a processor configured to transform video signal to at least two types of signals; and
a box connector receiving the at least two types of signals, the box connector configured to be coupled to a base connector on the base and output the at least two types of signals via the base connector.

2. The computing box of claim 1, wherein the at least two types of signals comprises HDMI signal and at least one USB signal.

3. The computing box of claim 2, wherein box connector is configured to output the HDMI signal and the at least one USB signal simultaneously via the base connector.

4. The computing box of claim 1, wherein the computing box comprises a wireless communication module, a function switch, and an indicator, the function switch is configured to turn on or off the wireless communication module, and the indicator is configured to indicate a work state of the wireless communication module.

5. The computing box of claim 1, wherein the computing box comprises a wireless communication module, the processor configures the wireless communication module to be a wireless access point for a mobile phone or a tablet computer remote desktop connecting with the computing box.

6. The computing box of claim 5, wherein the wireless communication module is a WiFi module, or a bluetooth module, or a combination module combining the WiFi module and the bluetooth module.

7. The computing box of claim 1, wherein the computing box comprises a fingerprint reader, and the fingerprint reader is configured to detect a fingerprint to log in the computing box.

8. A base configured to be coupled to a computing box, the base comprising:
at least one interface;
a base connector coupled to the at least one interface and configured to be coupled to a box connector on a computer box,
wherein the base connector is configured to receive at least one kind of video signal from the box connector and the at least one interface is configured to output the at least one kind of video signal to a display device coupled to the at least one interface.

9. The base of claim 8, wherein the at least one interface comprises a HDMI interface and at lest one USB interface, the at least one kind of video signal comprises HDMI signal and at least one USB signal, the HDMI interface is configured to output the HDMI signal, and the at least one USB interface is configured to output the at least one USB signal.

10. The base of claim 9, wherein the at least one USB interface comprises a USB type C interface, a USB 2.0 interface, and a USB 3.0 interface, the at least one USB signal comprises USB 2.0 signal, USB 3.0 signal, USB 3.1 signal, HDMI signal, the USB type C interface is configured to output the USB 3.1 signal, the USB 2.0 interface is configured to output the USB 2.0 signal, and the USB 3.0 interface is configured to output the USB 3.0 signal.

11. A host computer, comprising:
a computing box comprising a box connector, the computing box configured to output at least two different kinds of video signals via the box connector; and
a base comprising a first interface, a second interface, and a base connector connected to the box connector, the first interface configured to receive one of the at least two different kinds of video signals, the second interface configured to receive the other one of the at least two different kinds of video signals;
wherein the first interface is configured to output the one of the at least two different kinds of video signals to a display device, and the second interface is configured to output the other one of the at least two different kinds of video signals to another display device.

12. The host computer of claim 11, wherein the first interface is a HDMI interface.

13. The host computer of claim 12, wherein the second interface is a USB interface

14. The host computer of claim 13, wherein the at least two different kinds of video signals comprises USB signal and HDMI signal, the USB interface receives the USB signal, and the HDMI interface receives the HDMI signal.

15. The host computer of claim 11, wherein the computing box comprises a wireless communication module.

16. The host computer of claim 15, wherein the computing box further comprises a function board, a function switch and an indicator, and the function board configures the function switch to control the wireless communication module on or off, and the indicator is configured to indicate a work state of the wireless communication module.

17. The host computer of claim 16, wherein the wireless communication module is configured to be a wireless access point for a mobile phone or a tablet computer remote desktop connecting with the computing box via the wireless access point.

18. The host computer of claim 15, wherein the wireless communication module is a WiFi module, or a bluetooth module, or a combination module combining the WiFi module and the bluetooth module.

19. The host computer of claim 11, wherein the computing box comprises a fingerprint reader, and the fingerprint reader is configured to detect a fingerprint to log in the computing box.

20. The host computer of claim 11, wherein the first interface of the base is configured to connect a display monitor or a television, and the second interface of the base is configured to connect a mobile phone or a tablet computer, and the mobile phone or the tablet computer is remote desktop connected to the computing box to control the computing box by inputting on the mobile phone or the tablet computer.
